(19) United States
(12) Patent Application Publication
(10) Pub. No.: US 2025/0336141 A1
(43) Pub. Date: Oct. 30, 2025

(54) GRAPHICS PROCESSING

(71) Applicant: Arm Limited, Cambridge (GB)

(72) Inventors: Prithvi-Ansh Sebastiano Kohli, East Molesey (GB); Robert Conor Brigg, Watford (GB)

(73) Assignee: Arm Limited, Cambridge (GB)

(21) Appl. No.: 18/649,068

(22) Filed: Apr. 29, 2024

(51) Int. Cl. G06T 15/06; G06F 9/50

(52) U.S. Cl. CPC G06T 15/06; G06F 9/50

(57) ABSTRACT

When performing ray tracing in a graphics processing system, relative numbers of rays to be traced for different regions of a render output are determined. M groups threads, are then allocated to a region of the render output. The number of rays to be traced by each of the threads for a respective allocated subregion of the region is determined, based on the relative number of rays to be traced for the region and a ray tracing budget B for the render output. Ray tracing is then performed for the region, including each thread tracing the determined number of rays.

### BACKGROUND

The technology described herein relates to graphics processing systems, and in particular to the rendering of frames (images) for display.

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

One rendering process that may be performed by a graphics processor is so-called “ray tracing”. Ray tracing is a rendering process which involves tracing the paths of rays of light from a viewpoint (sometimes referred to as a “camera”) back through sampling positions in an image plane into a scene, and simulating the effect of the interaction between the rays and objects in the scene. The output data value (e.g. colour) for a sampling position in the frame (image) is determined based on the object(s) (if any) in the scene intersected by the ray passing through the sampling position, and the properties of the surfaces of those objects. The ray tracing calculation is complex, and involves determining, for each sampling position, a set of zero or more objects within the scene which a ray passing through the sampling position intersects.

Ray tracing is considered to provide better, e.g. more realistic, physically accurate images than more traditional rasterisation rendering techniques, particularly in terms of the ability to capture reflection, refraction, shadows and other lighting effects. Typically, the more rays that are traced when generating a render output (e.g. frame) or a region thereof, the more realistic and accurate the results.

However, performing ray tracing is typically computationally expensive. Because of this, when performing so called “real time” ray tracing, it is typical for only a few rays to be traced for each sampling position of the render output (e.g. frame) being generated. This typically results in a highly noisy output frame. Normally, a denoiser is used transform the noisy frame into a frame of appropriate image quality.

However, in some circumstances, such denoisers may be limited in their ability to reduce noise, e.g. in certain regions of the frame being generated. For example, various non-machine learning denoisers accumulate and average ray tracing data for sampling positions over a plurality of frames in order to carry out the denoising process. Therefore, if there is change in the scene for a particular region of the render output being generated, meaning that there is less relevant data available from previous frames for the denoiser to use, this can affect the denoiser performance.

One example where such a change may occur are so-called disocclusions, i.e. areas that were not visible to the camera in previous frames (e.g. because they were outside the view frustum or hidden behind another object), but are now visible to the camera in the frame being generated. Since there is no previous ray tracing data for the denoiser to rely on for these regions, temporal accumulation by the denoiser cannot be applied, and the denoised results will have a reduced image quality.

The Applicants believe that there remains scope for improved arrangements for performing ray tracing using a graphics processor.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 is a schematic diagram illustrating a “full” ray tracing process;

FIG. 3 shows an exemplary ray tracing acceleration data structure;

FIG. 4 shows in more detail an exemplary multi-level arrangement of ray tracing acceleration data structures that may be used according to embodiments of the technology described herein;

FIG. 5 is a flow chart illustrating an embodiment of a full ray tracing process;

FIG. 6 shows schematically an embodiment of a graphics processor that can be operated in the manner of the technology described herein;

FIG. 7 shows a flow diagram of a ray tracing process according to an embodiment of the technology described herein;

FIG. 8 shows a sample map and thread cycling process according to an embodiment of the technology described herein;

FIG. 9 shows a process for allocating rays to be traced when generating three consecutive frames for display according to an embodiment of the technology described herein; and

FIG. 10 shows a flow diagram of a ray tracing process according to an embodiment of the technology described herein.

### DETAILED DESCRIPTION

A first embodiment of the technology described herein comprises a method of operating a graphics processor to generate a render output made up of a plurality of sampling positions by performing a ray tracing process in which rays are traced through a scene to be rendered, wherein the total number of rays to be traced when generating the render output is based on a ray tracing budget B, and wherein different numbers of rays can be traced for different regions of the render output, the method comprising:
determining relative numbers of rays to be traced for different regions of the render output;
allocating M groups of threads to a region of the render output to perform the ray tracing for the region of the render output, each thread of the M groups of threads being allocated to a subregion of the region to perform ray tracing for the subregion;
determining the number of rays to be traced by each thread of the M groups of threads when performing ray tracing for the subregion to which they have been allocated based on the relative number of rays to be traced for the region of the render output and the budget B of rays to be traced when generating the render output;
performing ray tracing for the region, including each of the threads tracing the determined number of rays for the subregion to which they have been allocated.

A second embodiment of the technology described herein comprises a graphics processor that is operable to generate a render output made up of a plurality of sampling positions by performing a ray tracing process in which rays are traced through a scene to be rendered, wherein the total number of rays to be traced when generating the render output is based on a ray tracing budget B, and wherein different numbers of rays can be traced for different regions of the render output, the graphics processor comprising:
a processing circuit configured to determine relative numbers of rays to be traced for different regions of the render output;
a thread group allocation circuit configured to allocate M groups of threads to a region of a render output to perform ray tracing for the region of the render output, each thread of the M groups of threads being allocated to a subregion of the region to perform ray tracing for the subregion;
a number of rays determining circuit configured to determine the number of rays to be traced by each thread of the M groups of threads when performing ray tracing for the subregion to which they have been allocated, based on the relative number of rays to be traced for the region of the render output and the budget B of rays to be traced when generating the render output; and
one or more processing circuits configured to perform ray tracing for a region of a render output, including each of the threads tracing the determined number of rays for the subregion to which they have been allocated.

In the technology described herein, when ray tracing is to be performed to generate a render output (e.g. frame), different numbers of rays are traced for different regions of the render output.

The Applicants have recognised in this regards that, e.g., the ineffectiveness of a denoiser in respect of disocclusions means that it may be desirable to trace more rays for sampling positions corresponding to disoccluded areas, so that more accurate results for those sampling positions may be obtained (without the use of the denoiser).

It would be possible to, e.g., choose to trace a given number of rays for a region based solely on the content of the region. For example, it would be possible to (e.g. always) trace a first (higher) number of rays for a region that require more rays (e.g. because it contains a disocclusion), and trace a second (lower) number of rays for a region that requires less rays (e.g. it doesn't contain a disocclusion).

However, the applicants have recognised this may result in a very variable number of rays being traced when generating the render output as a whole. For example, in a case wherein there happens to be many regions that are determined to require a larger number rays to be traced, this may result in a very large number of rays being traced when generating the (entire) frame, which may be undesirable.

In the technology described herein, rather than simply tracing a given number of rays for a region based solely on the content of that region (which could, as discussed above, result in large numbers of rays being traced for the frame) there is a selected ray tracing budget B for the render output being generated, i.e. a total number of rays that may be traced when generating the whole render output, which acts to effectively constrain the number of rays to be traced for each region.

Instead of, e.g., simply assigning numbers or rays to be traced for different regions of the render output, in the technology described herein, relative numbers of rays to be traced for different regions of the render output are determined, e.g. with one or more (e.g. disoccluded) regions being determined to require a higher relative number of rays to be traced compared to other (e.g. non-disoccluded) regions.

To actually render a region of the render output, one or more groups of threads are allocated to the region, with individual threads of the one or more thread groups being allocated to different subregions (e.g. groups of sampling positions) of the region.

An actual number of rays to be traced by each of the threads (for their respective subregions) is then determined, based on both the relative number of rays to be traced for the region and the ray tracing budget B. Each of the threads then traces this determined actual number of rays for their respective subregion, in order to carry out the ray tracing for the region as a whole.

The Applicants have recognised that by constraining the total number of rays to be traced for a frame and allocating rays to be traced for different regions based on their relative needs, rays are distributed across the frame in such a manner as to provide more rays to those areas that would benefit from more rays, whilst ensuring that the total number of rays that are traced when rendering the frame is kept to a reasonable (target) level.

Furthermore, by using each thread of a group of threads to trace a determined (e.g. same) actual number of rays for each subregion of the region, this provides a computationally efficient way of carrying out the ray tracing work. Since it will take each thread roughly the same amount of time to perform the ray tracing for the subregion they are allocated to as other threads of the thread group, each thread is allocated a roughly same amount of work, thereby helping to ensure coherency of the thread group.

The regions of the render output, for which different numbers of rays can be traced and for which different relative numbers of rays to be traced are determined, can be any suitable regions that the render output is subdivided into. The regions may be any suitable size or shape. The regions are in an embodiment all the same size and shape (such as a rectangle, e.g. square), although this need not necessarily be the case. In an embodiment, the regions are 8×8 sampling positions in size.

In some embodiments, the method of the technology described herein is a so-called “tile based” rendering method, wherein the render output is divided a plurality of (in an embodiment regularly sized) tiles for the purposes of rendering. In these embodiments, the regions of the technology described herein (for which different numbers of rays can be traced and for which different relative numbers of rays to be traced are determined) can directly correspond to the tiles of the render output. However this need not necessarily be the case. For example, a region of the render output could correspond to (i.e. cover) a number of different (e.g. adjoining) tiles of the render output, or it could correspond to a fraction of a tile (i.e. such that a single tile covers a plurality of such regions of the render output).

The ray tracing budget B, which corresponds to a total number of rays to be traced when generating the (e.g. entire) render output, can be selected in any suitable or desired manner. The ray tracing budget B could be selected by the application (e.g. game) that is being executed (e.g. on a host processor), or the ray tracing budget B could be set by the graphics processor itself.

The ray tracing budget B could correspond to an estimated maximum number of rays that are supported by the rendering pipeline of the GPU, and/or that can be traced in a target amount of time for rendering the render output. In embodiments, a same ray tracing budget B value is chosen for multiple render outputs being rendered, i.e. such that approximately equal numbers of rays are traced for different (e.g. subsequent) frames that are being generated. However, this need not necessarily be the case, and it would be possible to instead choose different ray tracing budgets for different frames.

As discussed above, in the technology described herein, before performing ray tracing for regions of the render output, the relative numbers of rays to be traced for different regions of the render output is determined. This can be done in any suitable or desired manner.

In embodiments, the relative number of rays to be traced for a region is determined based on data indicating the presence of sampling positions (in different regions of the render output) that could particularly benefit from receiving more ray tracing samples, e.g. because the sampling positions of the region contain one or more particular features.

In some embodiments, the data indicates sampling positions covering areas of the scene being rendered that relate to one or more of: disocclusions (i.e. areas that were (in previous frames) not visible to the camera (e.g. because they were outside the view frustum or behind another object), but are now visible to the camera), specular highlights, areas of high temporal (spatiotemporal) variance and/or soft shadows, any or all of which may indicate that the sampling positions could benefit from receiving more ray tracing samples when generating the render output. In these embodiments, this data is in an embodiment received from an earlier stage in the graphics processing pipeline, e.g. in the case wherein the graphics processor is a so-called hybrid graphics processor which utilises both rasterization and ray-tracing rendering processes.

In some (other) embodiments, the data indicates sampling positions having a corresponding position to a sampling position in one or more previously generated render outputs (frames) that have been flagged by a learned algorithm or neural network (e.g. the denoiser) as being potentially erroneous or exceptional (e.g. because it resulted in a large delta or error value). This data may comprise feedback data that is received from the denoiser itself, for example.

In embodiments, the data indicating the presence of sampling positions (in different regions of the render output) that could particularly benefit from receiving more ray tracing samples is used to generate a sample density distribution map, which is then used to determine the relative numbers of rays to be traced for different regions of the render output.

The sample density distribution map in an embodiment comprises an array of sampling positions, each sampling position corresponding to a sampling position of the frame being generated. The sample density distribution map therefore in an embodiment has the same dimensions (and resolution) of the render output being generated.

In an embodiment, a value of each sampling position is set according to whether or not the data indicates that the corresponding sampling position in the render output being generated is a sampling position that could particularly benefit from receiving more ray tracing samples. In other words, sampling positions in the sample density distribution map corresponding to sampling positions in the render output being generated that could particularly benefit from receiving more ray tracing samples are assigned one (first) value, but all other sampling positions are assigned another (in an embodiment different, in an embodiment lower) (second) value.

It would be possible to for the first value to be 1 and the second value to 0, such that the sample density distribution map would comprise a simple bitmap. However, in embodiments, both the first and second value are (different) integer values. In one embodiment, the first value is equal to 10, and the second value is equal to 1.

The values (that are set of each sampling position) could be, and in some embodiments are, continuous (rather than discrete) values. For example, in a case wherein the data indicates sampling positions that have temporal variance, the values for each sampling positions could be (e.g. set to be) equal to the temporal variance value for the sampling position.

In some embodiments, the sample density distribution map comprises a plurality of channels. In these embodiments, the different channels may be used to target different features to which the sampling position relates that could particularly benefit from receiving more ray tracing samples.

For example the sample density distribution map could comprise a first channel comprising values according to whether or not the corresponding sampling position is a disoccluded sampling position, and a second channel comprising values according to whether or not the corresponding sampling position covers a specular highlight. Other arrangements are of course possible, however.

In embodiments, once the sample density distribution map has been generated (e.g. in the manner described above) it is used to determine the relative number of rays that should be traced for different regions of the render output. This can be done in any suitable or desired manner.

For example, it would be possible to determine a relative number of rays that should be traced for a region of the render output by simply adding up the values of all the sampling positions in the sample density distribution map that correspond to the sampling positions of the region of the render output being generated.

However, in an embodiment of the technology described herein, the relative numbers of rays to be traced for different regions of the render output is instead determined by downsampling the sample density distribution to generate a downsampled sample map, each sampling position of the downsampled sample map corresponding to a respective region of the render output being generated and having a value that corresponds to the relative number of rays to be traced for that region.

The downsampled sample density map should (and in an embodiment does) comprise a number of sampling positions that is equal to the number of regions of the render output (for which a relative number of rays to be traced is to determined). Therefore in an embodiment, when downsampling the sample density map to generate the downsampled sample map, an appropriate downsampling factor is chosen which will result in the downsampled sampling density map having the desired number of sampling positions.

For example, in the embodiment discussed above, wherein each region of the render output comprises an 8×8 block of sampling positions, the sample density distribution map is in an embodiment downsampled by a factor of 8 to generate the downsampled sample map.

The downsampling of the sample density distribution map may be carried out using any suitable or desired downsampling operation. In an embodiment, a max-pooling operation is used. As will be understood, this means that the value of a sampling position in the downsampled sample map (that corresponds to the relative number of rays to be traced for the corresponding region of the render output, as discussed above) will be equal to the maximum value of sampling positions in the sample density distribution map that correspond to the sampling positions that make up the region in the render output.

For example, if a first region of the render output comprises an 8×8 block of sampling positions (i.e. 64 sampling positions in total) and values for the corresponding 64 sampling positions in the sample density distribution map comprise a mixture of 1 or 10 values, then the value for the sampling position corresponding to the region in the downsampled sample map will be equal to 10 (i.e. the maximum value). If a second region of the render output comprises a different 8×8 block of sampling positions (i.e. 64 sampling positions in total) and values for the corresponding 64 sampling positions in the sample density distribution map comprise only 1 values, then the value for the sampling position corresponding to the region in the downsampled sample map will be equal to 1. This implies that ten times more rays will be traced for the first region of the render output, relative to the second render output.

In the technology described herein, to actually perform the ray tracing for a region of the render output (in accordance with the relative number of rays to be traced for the region, as discussed above) M groups (warps) of threads are allocated to the region.

It would be possible for only a single thread to be allocated to the region of the render output to perform ray tracing for the region (i.e. such that a single “group” (M=1) comprising a single thread is allocated to the region). In an embodiment, however, one or more thread groups comprising a plurality of threads are allocated to the region.

In an embodiment, each of the M thread groups comprises a same number of threads N that are allocated (i.e. such that a total of M*N threads are allocated to the region). This need not necessarily be the case, however, and it would be possible to allocate thread groups having different numbers of threads to the region.

When allocating one or more groups of threads to the region of the render output, threads are allocated to subregions of the render output to perform ray tracing for those subregions of the region. The region can therefore be considered to be made up of a plurality of said subregions, to which individual threads of the thread group are allocated.

In some embodiments, one or more (and in an embodiment each) of the subregions (to which threads are allocated) comprises a single sampling position of the region (such that a thread is allocated to perform ray tracing for a single sample position).

In other embodiments, one or more (and in an embodiment each) of the subregions (to which threads are allocated) comprises a plurality of sampling positions of the region (such that a thread is allocated to perform ray tracing for a plurality of sampling positions). In these embodiments, the subregions are in an embodiment all of the same size (i.e. comprising a same number of sampling positions) and shape. In one such embodiment, each of the subregions comprises a 2×2 “quad” of four sampling positions.

The number of threads of the M thread groups is in an embodiment such that there is a sufficient number of threads available so that for each subregion (that the region is made up of) is able to be allocated to one or more of, and in an embodiment a same number of, threads.

In an embodiment, each (and every) subregion that the region comprises is allocated to a single respective thread, such that there is a 1:1 mapping between threads and subregions. For example, in a case wherein there are M groups of N threads (i.e. M*N threads in total) that are allocated to the region of the render output, it is therefore in an embodiment the case that the region comprises a corresponding number of M*N subregions (with each of those M*N subregions being allocated to a respective one of the M*N threads).

Thus in an embodiment a region comprises M*N subregions, and each of the M*N threads are allocated to a respective one of the subregions.

In some embodiments, M is equal to 1, i.e. a single group of N threads is allocated to a region of the render output. In these embodiments, the region is in an embodiment made up of N subregions, such that each of the N threads of the thread groups are allocated to a respective one of the N subregions.

In one such embodiment, wherein the region comprises an 8×8 block of sampling positions, M is equal to 1 and N is equal to 16, such that 16 threads (of the thread group allocated to the region) are allocated to a respective 16 subregions that make up the 8×8 region, wherein each of the subregions comprises a 2×2 quad of subregions.

In other embodiments, M is greater than 1, such that multiple groups of threads of are allocated to a (single) region of the render output. In one such embodiment, wherein the region comprises an 8×8 block of sampling positions, M is equal to 4 and each thread group comprises 16 threads (i.e. N is equal to 16), such that 64 threads (i.e. made up of 4 groups of 16 threads) are allocated to respective subregions that each comprise a single sampling position. In this case, 64 threads are allocated perform ray tracing for each of 64 respective sampling positions of the render output (such that there is a 1:1 mapping of threads to sampling positions).

In some embodiments, the number M of groups of threads that are allocated to a region of the render output is chosen based on a determined number of rays that are to be traced for the (e.g. entire) region. In an embodiment, in these embodiments, a higher number M of groups of threads are allocated to region of the render output when there is determined to be a higher number of rays to be traced for a region of the render output.

In an embodiment, a higher number M groups of threads are allocated to a region of the render output when the determined number of rays that are to be traced for the region is (e.g. equal to or) above a selected (e.g. predetermined) threshold value.

In an embodiment, this threshold value corresponds to the number of sampling positions that the region comprises. In other words, a higher number of M groups of threads (and thus a higher number of threads in total) are allocated to a region of the render output if there if the number of rays to be traced per sampling position of the render output is equal to or above 1.0.

For example, in an embodiment, wherein a region comprises an 8×8 block of sampling positions (i.e. 64 sampling positions in total) a single group of 16 threads is allocated to a region of the render output (i.e. such that M=1) when the number of rays to be traced for the region is less than 64 (such that the number of rays to be traced per sampling position is less than 1.0), but four groups of 16 threads (i.e. 64 threads in total) are allocated to a region of the render output when the number of rays to be traced for the region is 64 or over (such that the number of rays to be traced per sampling position is more than 1.0).

In these embodiments, wherein the number M of groups of (e.g. N) threads (and hence the number of threads in total) that can be allocated to a region of the render output is chosen (based on the determined number of rays to be traced for the region), it is in an embodiment the case that the number of subregions that the region is divided into is also chosen accordingly.

For example, in the example discussed above, wherein either M=1 or M=4 groups of 16 threads are allocated to an 8×8 region of the render output, when M=1 (i.e. a single group of 16 threads is allocated) the region in an embodiment comprises 16 subregions (each subregion comprising a 2×2 quad of four sampling positions), such that each of the 16 threads can be allocated to a single respective subregion. Similarly, when M=4 (i.e. four groups of 16 threads are allocated) the region in an embodiment comprises 64 subregions (each subregion comprising a single sampling position) such that each of the 64 threads can be allocated to a single respective subregion.

In the technology described herein, the number of rays to be traced by each of the threads (for the subregion they have been allocated to) is determined based on the relative number of rays to be traced for the region and the budget B of rays to be traced when generating the render output. This can be done in any suitable or desired manner. In an embodiment, a same number of rays is determined to be traced by each of the threads of the M thread groups.

In an embodiment, the number of rays to be traced by each of the threads of the M thread groups (for the subregion they have been allocated to) is determined by first determining an (e.g. approximate) number of rays to be traced for the (e.g. entire) region (based on the determined relative number of rays to be traced for the region and the ray tracing budget), from which the number of rays to be traced by each of the M*N threads (for their respective subregion) is then determined.

This (e.g. approximate) number of rays to be traced for the (e.g. entire) region of the render output can be (and in an embodiment is) determined by “normalising” the relative number of rays for the region, by (i) dividing the relative number of rays to be traced for the region by the sum of the relative numbers of rays to be traced for all of the regions of and (ii) multiplying the result by the ray tracing budget B. (As will be understood, these two operations can be carried out in any order).

Thus, according to an embodiment, determining the number of rays to be traced by each of the threads when performing ray tracing for the subregion to which they have been allocated comprises:
determining an approximate number of rays to be traced for the region of the render output by multiplying the relative number of rays to be traced for the region by the ray tracing budget B, divided by the sum of all the relative numbers of rays to be traced for all of the regions of the render output.

In an embodiment, wherein (and as described above) a downsampled sample map is determined (with sampling positions that correspond to regions of the render output having values that are equal to the relative number of rays to be traced for the region) the number of rays to be traced for a region is determined by “normalising” value of the corresponding sampling position in the downsampled sample map by (i) dividing the value by the sum of all the values (corresponding to all the regions) of the downsampled sample map and (ii) multiplying the result by the ray tracing budget B.

Thus, for example, in a case wherein a render output comprises 16 regions, each region having a value in the downsampled sample map of 2, and the budget of rays for the render output being equal to 160, the number of rays to be traced for a region would be equal to 2 (i) divided by 2*16=32 (ii) multiplied by 160, i.e. 10 rays.

Once the total number of rays to be traced for a region is determined (e.g. in the manner described above), it would be possible to divide this total number of rays amongst the different threads of the M thread groups by simply allocating different numbers of rays to different threads of the M thread groups. For example, in a case wherein the number of rays to be traced for the region is determined to be 18, and there is one group of 16 threads allocated to the region (i.e. such that M=1), it would be possible to spread these rays amongst the sixteen rays by e.g. allocating two rays to two of the 16 threads, and one ray to the other 14 of the 16 threads.

In an embodiment, however, wherein each of the M threads groups allocated to a region comprises N threads (such that M*N threads are allocated to the region), the determined (approximate) number of rays to be traced for a region is in an embodiment first rounded (e.g. up or down) to a nearest multiple of M*N, with this rounded value then being divided by M*N to give the number of rays to be traced by each of the M*N threads.

The Applicants have recognised that such rounding will ensure that each of the threads of the thread group(s) can trace a same (integer) number of rays for each subregion, thereby providing a computationally efficient way of carrying out the ray tracing work. Since it will take each thread roughly the same amount of time to perform the ray tracing for the subregion they are allocated to as other threads of the thread group, each thread is allocated a roughly same amount of work, thereby helping to ensure coherency of the thread group.

Thus according to an embodiment, the method includes (and the system is correspondingly configured to) rounding the determined (approximate) number of rays to be traced for the region to a nearest multiple of M*N, and dividing this rounded value by M*N to give the number of rays to be traced by each of the M*N threads when performing ray tracing for the subregion to which they have been allocated.

In embodiments, each thread is determined to (and subsequently does) trace a minimum of one ray for the subregion to which they have been allocated (to ensure that the subregion that each thread is allocated to receives some new ray tracing information for the render output that is generated). In embodiments, this is done by rounding the approximate number of rays to be traced for the region of the render output up to the nearest multiple of M*N (rather than down). (Other ways of ensuring that at least one ray is traced by each thread are of course possible, however.)

In embodiments wherein each thread is determined to (and subsequently does) trace a minimum of one ray for the allocated subregion in this manner (e.g. by “rounding up” the approximate rays for the region, as discussed above), this can be (and in some embodiments is) accounted for when determining the number of rays that are to be traced by each thread, so that the total number of rays that are traced when rendering the render output does not exceed the ray tracing budget B. For example, in some embodiments, rather than using the “raw” ray tracing budget B in the calculations (as described above) to determine a number of rays to be traced by each thread, this value is first reduced by the number of rays that are traced (by all of the threads) as the “minimum” for all of the subregions (across the entire render output), thereby giving the effective number of rays that can be allocated to different regions/subregions (and hence threads) of the render output whilst ensuring that the total ray tracing budget B is not exceeded.

Once the number of rays to be traced by each of the threads has been determined, each of the threads then traces the determined number of rays (for the subregion to which they are allocated). This can be done in any suitable or desired manner, e.g. according to any suitable or desired ray tracing process.

In an embodiment, the threads trace one or more rays for one or more (individual) sampling positions of the subregion. (The results of the ray tracing may then be written out (e.g. to an image buffer). In cases wherein more than one ray is traced for a particular subregion, the results for each ray could be written out separately, or averaged together before being written out, etc. and so on.)

In embodiments (discussed above), wherein the subregion to which a thread is allocated comprises a single sampling position (of the region of the render output), the thread in an embodiment traces the determined number of rays in respect of that (single) sampling position (only).

In embodiments (discussed above) wherein the subregion to which a thread is allocated comprises a plurality of sampling positions, the thread should (and in an embodiment does) traces rays in respect of at least some of the plurality of sampling positions.

In embodiments, this is done by the thread cycling (i.e. iterating) over some (and in an embodiment each) of the sampling positions of the subregion in turn to trace one or more rays for one or more of the sampling positions of the subregion. Thus, in these embodiments, a thread would begin by tracing one or more rays for a particular sampling position of the subregion, before moving on to a next sampling position of the subregion to (e.g.) trace zero, one or more rays for that sampling position, etc. and so on, until the thread has finished looping through (in an embodiment each of) the sampling positions of the subregion.

Thus, in an embodiment of the technology described herein, wherein each of the subregions of the region comprises a plurality of sampling positions, each thread traces the determined number of rays for the subregion by cycling over sampling positions of its allocated subregion in turn to trace one or more rays for one or more of the sampling positions of the subregion.

The Applicants have recognised that cycling over sampling positions in this way provides an efficient means for a thread to trace rays for a plurality of sampling positions which is advantageous in its own right (irrespective of how the determination as to how many rays to be traced by each of the threads is made).

Thus another embodiment of the technology described herein comprises a method of operating a graphics processor to generate a render output made up of a plurality of sampling positions by performing a ray tracing process in which rays are traced through a scene to be rendered, the method comprising:
allocating a plurality of threads to a region of the render output, each thread being allocated to a subregion of the region to perform ray tracing for the subregion, each of the subregions of the region comprising a plurality of sampling positions; and
performing ray tracing for the region, including each of the threads tracing rays for its allocated subregion by cycling over sampling positions of its allocated subregion in turn to trace one or more rays for one or more of the sampling positions of the subregion.

Another embodiment of the technology described herein comprises graphics processor that is operable to generate a render output made up of a plurality of sampling positions by performing a ray tracing process in which rays are traced through a scene to be rendered, the graphics processor comprising:
a thread allocation circuit configured to allocate a plurality of threads to a region of a render output to perform ray tracing for the region of the render output, each thread being allocated to a subregion of the region to perform ray tracing for the subregion, each of the subregions of the region comprising a plurality of sampling positions; and
one or more processing circuits configured to perform ray tracing for a region of a render output, including each of the threads tracing rays for its allocated subregion by cycling over sampling positions of its allocated subregion in turn to trace one or more rays for one or more of the sampling positions of the subregion.

These embodiments and embodiments may comprise any one or more or all of the optional features described herein in any other embodiment or embodiment, as desired.

It would be possible for each thread to (e.g. only) be able to trace a same number of rays for each of the sampling positions of the subregion (to which the thread is allocated). However, in embodiments, the number of rays that a thread is able to trace in for the subregion to which it is allocated can be a number that is not a multiple of the number of sampling positions in the subregion. In these cases (and as will be understood), it is not possible to trace an equal (integer) number of rays for each of the sampling positions of the subregion, and hence different numbers of rays are traced for some sampling positions of the subregion compared to other sampling positions of the subregion (i.e. such that one or more sampling positions of the subregion have more rays traced for them than one or more other sampling positions of the subregion).

Thus, according to another embodiment of the technology described herein, the number of rays to be traced by each of the threads for the subregion to which they have been allocated is not a multiple of the number of sampling positions that each subregion comprises; and the method comprises (and the system is configured to) each thread tracing more rays for one or more sampling positions of the subregion to which it is allocated than for one or more other sampling positions of the subregion to which it is allocated.

The process of tracing different amounts of rays for different sampling positions of the subregion can be carried out in any suitable or desired manner.

In embodiments (discussed above), wherein the thread cycles over each of the sampling position of the subregion (to which it is allocated) in turn, this is in an embodiment done by the thread tracing a different number of rays for sampling positions according to the order in which the thread cycles over the sampling positions

This could be done by e.g. the thread tracing a different (e.g. higher) number of rays for sampling positions earlier in the cycle compared to sampling positions later in the cycle. In an embodiment, the thread traces one more ray for one or more sampling positions earlier in the cycle than for one or more sampling positions later in the cycle.

For example, in a case wherein a thread is to trace three rays for a subregion that comprises four sampling positions (in a 2×2 quad), the thread would trace a single ray for each of the first three sampling positions in the cycle, but would trace no ray for the final sampling position in the sample.

In some embodiments, each thread cycles over their sampling positions (i.e. the sampling positions of the subregion to which they are allocated) in a same (e.g. predetermined) order (including, e.g., beginning the cycle at a same (corresponding) sampling position of the subregion and, e.g., ending the cycle at a same (corresponding) sampling position of the subregion). For example, in an embodiment wherein each subregion comprises a 2×2 “quad” of sampling positions, the cycle could comprise (always) starting at the sampling position in the top left of the quad, then moving to the quad at the top right of the quad, then the sampling position in the bottom left of the quad, and finishing at the sampling position in the bottom right of the quad.

However, in an embodiment, rather than each thread cycling over the sampling positions of the subregion that it is allocated to in a same order in this manner, (at least some) different threads begin their cycles at different (and in an embodiment random) sampling positions (relative to one another).

For example, in an embodiment wherein each subregion comprises a 2×2 “quad” of sampling positions, the cycle for one thread could comprise starting at the sampling position in the top left of the quad, then moving to the sampling position at the top right of the quad, then the sampling position in the bottom left of the quad, and finishing at the sampling position in the bottom right of the quad (i.e. as described above), but the cycle for another thread could (instead) comprise starting at the sampling position in the bottom left of the quad, then moving to the sampling position at the bottom right of the quad, then the sampling position at the top left of the quad, and finishing at the sampling position at the top right of the quad.

As discussed above, it may be the case that different numbers of rays can be traced by a thread for different sampling positions, according to the order that the thread cycles over the sampling positions (e.g. with earlier sampling positions in the cycle having a ray for them but sampling positions later in the cycle having no ray traced for them). The Applicants have recognised that by having different (and in an embodiment each) thread (of the thread group(s)) start their cycle at a different (and in an embodiment random) position relative to (in an embodiment each) other thread of the thread group(s), this prevents any structured pattern (resulting from the sampling positions for which new rays are traced) being introduced into the render output that is being generated.

Thus according to an embodiment of the technology described herein, each thread starts the cycling over the sampling positions of its allocated subregion at a random sampling position of the subregion relative to the sampling position at which each other thread starts its cycle over the sampling positions of its allocated subregion.

The method of the technology described herein can be (and in embodiments is) repeated in order to render plural render outputs (e.g. successive frames for display). In some embodiments, same M groups of N threads are allocated to corresponding regions of the plural render outputs (with the same threads being allocated to corresponding subregions of those corresponding regions), when generating the render outputs.

In embodiments (discussed above) wherein threads cycle over the sampling positions of the subregion to which they are allocated, it would be possible for a thread to simply cycle over the sampling positions of the subregion to which it is allocated in the same (e.g. predetermined) order for different (e.g. successive) render outputs that are generated (including, e.g., beginning the cycle at a same (corresponding) sampling position of the subregion and, e.g., ending the cycle at a same (corresponding) sampling position of the subregion).

However, in an embodiment, rather than the thread cycling over the sampling positions (of the subregion that it is allocated to) in a same order for different render outputs that are generated in this manner, the thread cycles over the sampling positions in different orders for different frames that are generated.

In an embodiment, a thread changes (i.e. cycles) the starting sampling position at which the thread begins cycling over the sampling positions of its allocated subregion for each (successive) render output that is generated. In other words, the sampling position which starts the cycle is rotated each time a new render output is generated.

Thus, for example, in an embodiment wherein a thread is allocated to a subregion comprising a “quad” of sampling positions, the thread's cycle when generating a first render output could start at the sampling position at the top left of the quad (before cycling over the top right, bottom left and bottom right sampling positions), with that same thread's cycle when generating a second (i.e. next) render output then starting at the sampling position at the top right of the quad (before cycling over the bottom left, bottom right and top left sampling positions), with that same thread's cycle when generating a third (i.e. next) render output starting at the sampling position at the bottom left of the quad (before cycling over the bottom right, top left and top right sampling positions), and that same thread's cycle when generating a fourth (i.e. next) render output starting at the sampling position at the bottom right of the quad (before cycling over the top left, top right and bottom left sampling positions), and that same thread's cycle when generating a fifth (i.e. next) render output then starting at the sampling position at the top left of the quad (i.e. the same starting position as the cycle when generating the first render output), etc. and so on.

As discussed above, it may be the case that different numbers of rays can be traced by a thread for different sampling positions, according to the order that the thread cycles over the sampling positions (e.g. with earlier sampling positions in the cycle having a ray for them but sampling positions later in the cycle having no ray traced for them).

The Applicants have recognised that by cycling through the starting sampling position that each thread begins its cycle at for successive frames (in the manner described above), this ensures that each (corresponding) sampling position (across different render outputs) will always have a new ray traced for it at least once every certain number of render outputs that are generated (assuming there is at least one ray to be traced by the thread for each render output), and thus prevents certain (corresponding) sampling positions in the render outputs from going too long without receiving up-to-date ray tracing information.

In particular, for a subregion comprising S sampling positions, cycling the starting position will ensure that (corresponding) sampling positions have a new ray traced for them at least once every S render outputs that are generated.

Thus according to another embodiment of the render output repeating the method to successively generate one or more further render outputs having corresponding regions, each corresponding region comprising a corresponding set of subregions, each corresponding subregion being allocated to a same thread, and the method further comprises:
each thread cycling the sampling position at which the thread starts cycling over the sampling positions of each corresponding subregion to which it is allocated, when generating successive render outputs.

The technology described herein can be used for all forms of output that a graphics processor may output. Thus, it may be used when generating frames for display, for render-to-texture outputs, etc. The output from the graphics processor is, in an embodiment, exported to external, e.g. main, memory, for storage and use.

Subject to the requirements for operation in the manner of the technology described herein, the graphics processor can otherwise have any suitable and desired form or configuration of graphics processor and comprise and execute any other suitable and desired processing elements, circuits, units and stages that a graphics processor may contain, and execute any suitable and desired form of graphics processing pipeline.

In an embodiment, the graphics processor is part of an overall graphics (data) processing system that includes, e.g., and in an embodiment, a host processor (CPU) that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and, in an embodiment does, also execute a driver for the graphics processor and a compiler or compilers for compiling programs to be executed by the programmable execution unit of the graphics processor.

The overall graphics (data) processing system may, for example, include one or more of: a host processor (central processing unit (CPU)), the graphics processor (processing unit), a display processor, a video processor (codec), a system bus, and a memory controller.

The graphics processor and/or graphics (data) processing system may also comprise, and/or be in communication with, one or more memories and/or memory devices that store the data described herein, and/or the output data generated by the graphics processor, and/or that store software (e.g. (shader) programs) for performing the processes described herein. The graphics processor and/or graphics (data) processing system may also be in communication with a display for displaying images based on the data generated by the graphics processor.

It will be appreciated by those skilled in the art that all of the described embodiments of the technology described herein can, and in an embodiment do, include, as appropriate, any one or more or all of the features of the technology described herein described herein.

The technology described herein can be implemented in any suitable system, such as a suitably configured micro-processor based system. In an embodiment, the technology described herein is implemented in a computer and/or micro-processor based system. The technology described herein is in an embodiment implemented in a portable device, such as, and in an embodiment, a mobile phone or tablet.

The various functions of the technology described herein can be carried out in any desired and suitable manner. For example, the functions of the technology described herein can be implemented in hardware or software, as desired. Thus, for example, unless otherwise indicated, the various functional elements, stages, units, and “means” of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuitry/circuits), and/or programmable hardware elements (processing circuitry/circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages, etc., may share processing circuitry/circuits, etc., if desired.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display processor, or microprocessor system comprising a data processor causes in conjunction with said data processor said controller or system to carry out the steps of the methods of the technology described herein. Such a computer software carrier could be a physical storage intermediate such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory, computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable intermediate with accompanying printed or electronic documentation, for example, shrink wrapped software, preloaded with a computer system, for example, on a system ROM or fixed disk, or distributed from a server or electronic bulletin board over a network, for example, the Internet or World Wide Web.

Embodiments of the technology described herein will now be described by way of example only and with reference to the accompanying drawings.

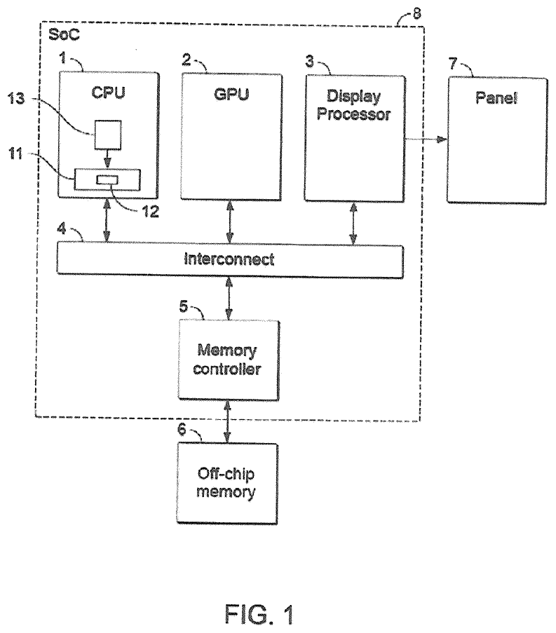

The present embodiments relate to the operation of a graphics processor, e.g. in a graphics processing system as illustrated in FIG. 1, when performing rendering of a scene to be displayed using a ray tracing based rendering process.

Ray tracing is a rendering process which involves tracing the paths of rays of light from a viewpoint (sometimes referred to as a “camera”) back through sampling positions in an image plane (which is the frame being rendered) into a scene, and simulating the effect of the interaction between the rays and objects in the scene. The output data value e.g. colour of a sampling position in the image is determined based on the object(s) in the scene intersected by the ray passing through the sampling position, and the properties of the surfaces of those objects. The ray tracing process thus involves determining, for each sampling position, a set of objects within the scene which a ray passing through the sampling position intersects.

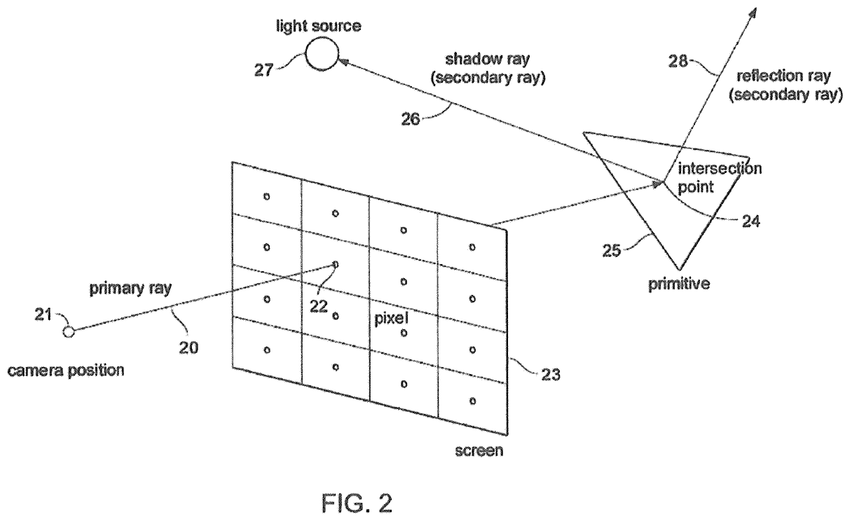

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object 25, e.g. a primitive (which primitives in the present embodiments are in the form of triangles, but may also comprise other suitable geometric shapes), in the scene is identified. This first intersection will be with the object in the scene closest to the sampling position.

A secondary ray in the form of shadow ray 26 may be cast from the first intersection point 24 to a light source 27. Depending upon the material of the surface of the object 25, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22 i.e. a colour value (e.g. RGB value) thereof, is then determined taking into account the interactions of the primary, and any secondary, ray(s) cast, with objects in the scene. The same process is conducted in respect of each sampling position to be considered in the image plane (frame) 23.

In order to facilitate such ray tracing processing, in the present embodiments acceleration data structures indicative of the geometry (e.g. objects) in scenes to be rendered are used when determining the intersection data for the ray(s) associated with a sampling position in the image plane to identify a subset of the geometry which a ray may intersect.

The ray tracing acceleration data structure represents and indicates the distribution of geometry (e.g. objects) in the scene being rendered, and in particular the geometry that falls within respective (sub-) volumes in the overall volume of the scene (that is being considered). In the present embodiments, ray tracing acceleration data structures in the form of Bounding Volume Hierarchy (BVH) trees are used.

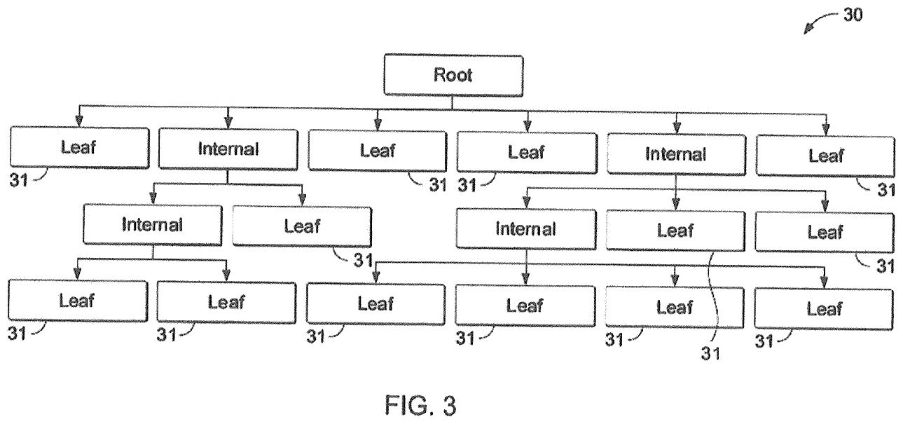

FIG. 3 shows an exemplary BVH tree 30, constructed by enclosing a volume in an axis-aligned bounding volume (AABV), e.g. a cube, and then recursively subdividing the bounding volume into successive sub-AABVs according to any suitable and desired subdivision scheme, until a desired smallest subdivision (volume) is reached.

In this example, the BVH tree 30 is a relatively “wide” tree wherein each bounding volume is subdivided into up to six sub-AABVs. However, in general, any other suitable tree structure may be used, and a given node of the tree may have any suitable and desired number of child nodes.

Thus, each node in the BVH tree 30 will have a respective volume associated with it, with the end, leaf nodes 31 each representing a particular smallest subdivided volume, and any parent node representing, and being associated with, the volume of its child nodes.

A complete scene may be represented by a single BVH tree, e.g. with the tree storing the geometry for the scene in world space. In this case, each leaf node of the BVH tree 30 may be associated with the geometry defined for the scene that falls, at least in part, within the volume that the leaf node corresponds to (e.g. whose centroid falls within the volume in question). The leaf nodes 31 may represent unique (non-overlapping) subsets of primitives defined for the scene falling within the corresponding volumes for the leaf nodes 31.

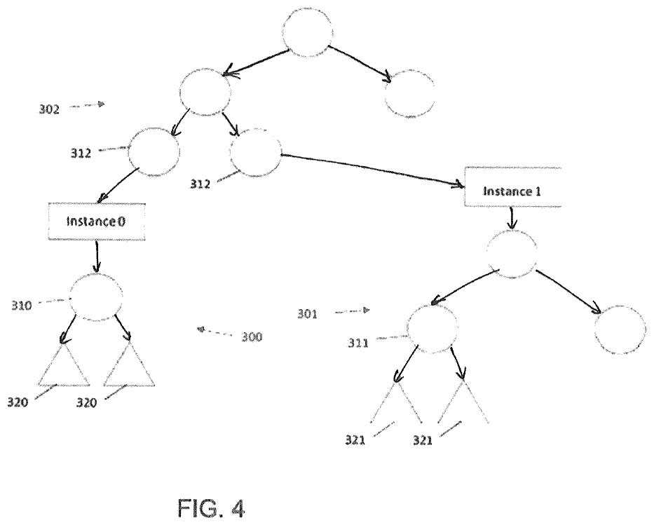

In the present embodiments, a two-level arrangement of ray tracing acceleration data structures is used to represent the distribution of geometry within the scene to be rendered. FIG. 4 shows an exemplary two-level arrangement of ray tracing acceleration data structures in which each instance or object within the scene is associated with a respective bottom-level acceleration structure (BLAS) 300, 301, which in the present embodiments is in the form of a respective BVH tree that stores geometry in model space, with each leaf node 310, 311 of the BVH tree representing a unique subset of primitives 320, 321 defined for the instance or object falling within the corresponding volume.

A separate top-level acceleration structure (TLAS) 302 then contains references to the set of bottom-level acceleration structures (BLAS), together with a respective set of shading and transformation information for each bottom-level acceleration structure (BLAS). In the present embodiments, the top-level acceleration structure (TLAS) 302 is defined in world space and is in the form of a BVH tree having leaf nodes 312 that each point to one or more of the bottom-level acceleration structures (BLAS) 300, 301.

The BVH tree acceleration data structure also stores (either for the nodes themselves or otherwise, e.g. as sideband information), appropriate information to allow the tree to be traversed volume-by-volume on the basis of the origin and direction of a ray so as to be able to identify a leaf node representing a volume that the ray passes through.

This then allows and facilitates testing a ray against the hierarchy of bounding volumes in the BVH tree until a leaf node is found. It is then only necessary to test the geometry associated with the particular leaf node for intersection with the ray.

Other forms of ray tracing acceleration data structure would be possible.

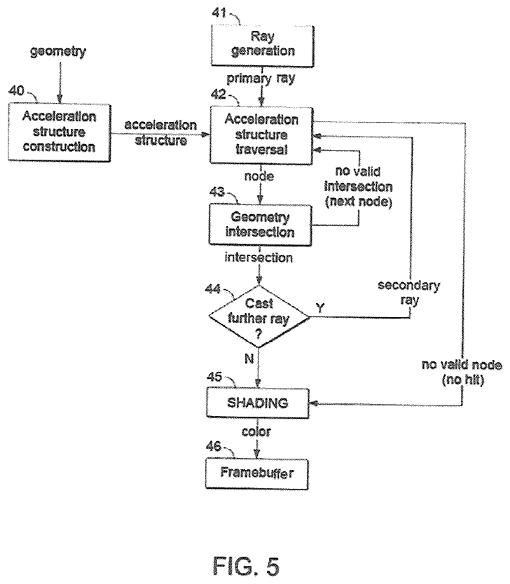

FIG. 5 is a flow chart showing the overall ray tracing process in embodiments of the technology described herein, and that will be performed on and by the graphics processor 2.

First, the geometry of the scene is analysed and used to obtain an acceleration data structure (step 40), for example in the form of a BVH tree structure, as discussed above. This can be done in any suitable and desired manner, for example by means of an initial processing pass on the graphics processor 2.

A primary ray is then generated, passing from a camera through a particular sampling position in an image plane (frame) (step 41). The acceleration data structure is then traversed for the primary ray (step 42), and the leaf node corresponding to the first volume that the ray passes through which contains geometry which the ray potentially intersects is identified. It is then determined whether the ray intersects any of the geometry, e.g. primitives, (if any) in that leaf node (step 43).

If no (valid) geometry which the ray intersects can be identified in the node, the process returns to step 42, and the ray continues to traverse the acceleration data structure and the leaf node for the next volume that the ray passes through which may contain geometry with which the ray intersects is identified, and a test for intersection performed at step 43.

This is repeated for each leaf node that the ray (potentially) intersects, until geometry that the ray intersects is identified

When geometry that the ray intersects is identified, it is then determined whether to cast any further (secondary) rays for the primary ray (and thus sampling position) in question (step 44). This may be based, e.g., and in an embodiment, on the nature of the geometry (e.g. its surface properties) that the ray has been found to intersect, and the complexity of the ray tracing process being used. Thus, as shown in FIG. 5, one or more secondary rays may be generated emanating from the intersection point (e.g. a shadow ray(s), a refraction ray(s) and/or a reflection ray(s), etc.). Steps 42, 43 and 44 are then performed in relation to each secondary ray.

Once there are no further rays to be cast, a shaded colour for the sampling position that the ray(s) correspond to is then determined based on the result(s) of the casting of the primary ray, and any secondary rays considered (step 45), taking into account the properties of the surface of the object at the primary intersection point, any geometry intersected by secondary rays, etc. The shaded colour for the sampling position is then stored in the frame buffer (step 46).

If no (valid) node which may include geometry intersected by a given ray (whether primary or secondary) can be identified in step 42 (and there are no further rays to be cast for the sampling position), the process moves to step 45, and shading is performed. In this case, the shading is in an embodiment based on some form of “default” shading operation that is to be performed in the case that no intersected geometry is found for a ray. This could comprise, e.g., simply allocating a default colour to the sampling position, and/or having a defined, default geometry to be used in the case where no actual geometry intersection in the scene is found, with the sampling position then being shaded in accordance with that default geometry. Other arrangements would, of course, be possible.

This process is performed for each sampling position to be considered in the image plane (frame).

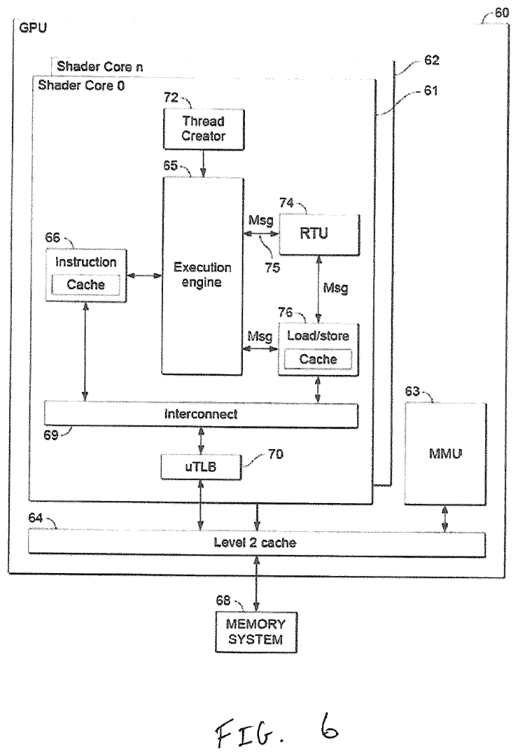

FIG. 6 shows schematically the relevant elements and components of a graphics processor (GPU) 60 of the present embodiments.

As shown in FIG. 6, the GPU 60 includes one or more shader (processing) cores 61, 62 together with a memory management unit 63 and a level 2 cache 64 which is operable to communicate with an off-chip memory system 68 (e.g. via an appropriate interconnect and (dynamic) memory controller).

FIG. 6 shows schematically the relevant configuration of one shader core 61, but as will be appreciated by those skilled in the art, any further shader cores of the graphics processor 60 will be configured in a corresponding manner.

(The graphics processor (GPU) shader cores 61, 62 are programmable processing units (circuits) that perform processing operations by running small programs for each “item” in an output to be generated such as a render target, e.g. frame. An “item” in this regard may be, e.g. a vertex, one or more sampling positions, a ray, etc. The shader cores will process each “item” by means of one or more execution threads which will execute the instructions of the shader program(s) in question for the “item” in question. Typically, there will be multiple execution threads each executing at the same time (in parallel).)

FIG. 6 shows the main elements of the graphics processor 60 that are relevant to the operation of the present embodiments. As will be appreciated by those skilled in the art there may be other elements of the graphics processor 60 that are not illustrated in FIG. 6. It should also be noted here that FIG. 6 is only schematic, and that, for example, in practice the shown functional units may share significant hardware circuits, even though they are shown schematically as separate units in FIG. 6. It will also be appreciated that each of the elements and units, etc., of the graphics processor as shown in FIG. 6 may, unless otherwise indicated, be implemented as desired and will accordingly comprise, e.g., appropriate circuits (processing logic), etc., for performing the necessary operation and functions.

As shown in FIG. 6, each shader core of the graphics processor 60 includes an appropriate programmable execution unit (execution engine) 65 that is operable to execute graphics shader programs for execution threads to perform graphics processing operations.

The shader core 61 also includes an instruction cache 66 that stores instructions to be executed by the programmable execution unit 65 to perform graphics processing operations. The instructions to be executed will, as shown in FIG. 6, be fetched from the memory system 68 via an interconnect 69 and a micro-TLB (translation lookaside buffer) 70.

The shader core 61 also includes an appropriate load/store unit 76 in communication with the programmable execution unit 65, that is operable, e.g., to load into an appropriate cache, data, etc., to be processed by the programmable execution unit 65, and to write data back to the memory system 68 (for data loads and stores for programs executed in the programmable execution unit). Again, such data will be fetched/stored by the load/store unit 76 via the interconnect 69 and the micro-TLB 70.

In order to perform graphics processing operations, the programmable execution unit 65 will execute graphics shader programs (sequences of instructions) for respective execution threads (e.g. corresponding to respective sampling positions of a frame to be rendered).

Accordingly, as shown in FIG. 6, the shader core 61 further comprises a thread creator (generator) 72 operable to generate execution threads for execution by the programmable execution unit 65.

As shown in FIG. 6, the shader core 61 also includes a ray tracing circuit (unit) (“RTU”) 74, which is in communication with the programmable execution unit 65, and which is operable to perform the required geometry intersection determinations for rays being processed as part of a ray tracing-based rendering process (i.e. the operations of steps 42 and 43 of FIG. 4 of traversing the acceleration data structure to determine with reference to the node volumes of the acceleration data structure geometry that is potentially intersected by the ray and the corresponding ray-primitive testing to determine which geometry, if any, is actually intersected by the ray), in response to messages 75 received from the programmable execution unit 65.

The RTU 74 is also able to communicate with the load/store unit 76 for loading in the required data for such intersection testing, such as the node data defining the nodes to be tested (e.g. which node data may include data identifying a set of primitives, but could also identify a BLAS to be traversed, as well as any transform that is to be applied, for example).

In the present embodiments, the RTU 74 of the graphics processor is a (substantially) fixed-function hardware unit (circuit) that is configured to perform the required operations to determine geometry for a scene to be rendered that may be (and is) intersected by a ray being used for a ray tracing operation. However, some amount of configurability may be provided.

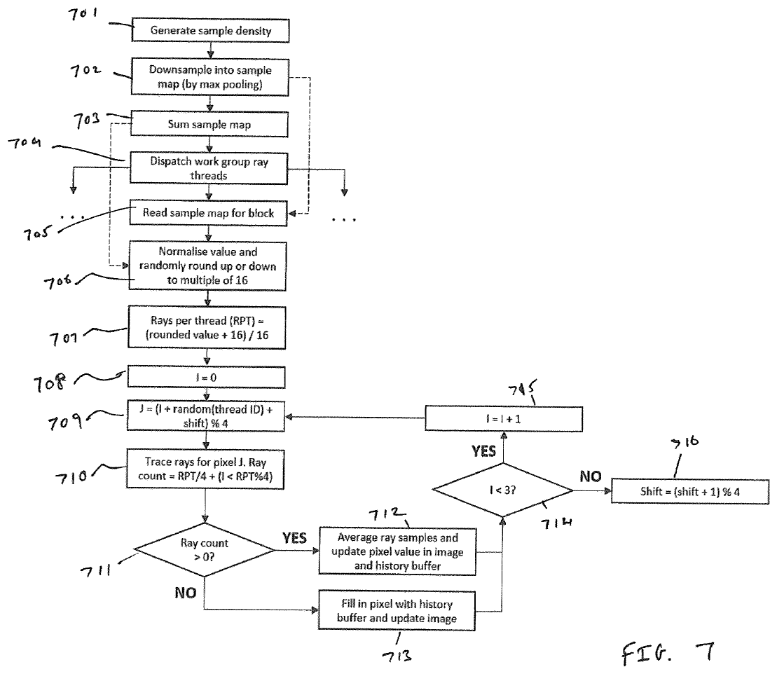

FIG. 7 shows a flow diagram of a ray tracing process according to an embodiment of the technology described herein.

FIG. 7 relates to the process of generating a frame in the case where the target total number of rays that to be traced when generating the frame (in its entirety) is a total ray tracing budget B.

The total “budget” B of ray samples for the frame is the total number of rays to be traced for all sampling positions of the frame being generated. In the present embodiment, the total budget of ray tracing samples for a frame to be generated is predetermined and set at a value to ensure that the frame can be rendered in a sufficiently small time period (since, as will be understood, increasing the number of samples to be traced for a frame being generated will also tend to increase the rendering time for that frame)

As will be discussed below, the ray tracing when generating the frame is carried out by allocating respective thread groups of 16 threads to each respective 8×8 block of sampling positions of the frame. The threads of the thread group perform ray tracing for the 8×8 block to which the thread group has been allocated. Different numbers of rays can be traced for different 8×8 blocks. More particularly, in this embodiment, 8×8 blocks of the frame that contain disoccluded areas are allocated more rays to be traced, relative to 8×8 blocks that do not include disoccluded areas.

At the beginning of the process, some prior data is received as an input which provides an indication as to which portions of the frame being generated would benefit from more ray tracing samples relative to other portions of the frame.

In the present embodiment, the prior data indicates areas in the scene being rendered that are disocclusions, i.e. sampling positions relating to areas that were (in previous frames) not visible to the camera (e.g. because they were outside the view frustum or behind another object), but are now visible to the camera in the frame being generated. However, the prior data could instead (or also) include, e.g. data indicating areas with specular highlights, high temporal variance and/or soft moving shadows, and/or an output from the denoiser.

In step 701, a sample density distribution map is generated based on the prior data indicating the areas of the frame that are disocclusions. The sample density distribution map comprises an array of sampling positions and has the same dimensions (and the same resolution) as the frame being generated, with each sampling position in the sample density distribution map corresponding to a sampling position of the frame being generated.

Each sampling position of the sample density distribution map being generated contains an integer number value that is representative of a relative number of ray samples that should be distributed (and traced) in respect of the corresponding sampling position in the frame being generated. In the present embodiment, sampling positions that are disoccluded are assigned the integer value 10, and non-disoccluded sampling positions are assigned an integer value of 1. As will be understood, this implies that disoccluded sampling positions will have roughly ten times more ray tracing samples (on average) than non-disoccluded sampling positions.

In step 702, a downsampled sample map is generated from the sample density distribution map. This is done by downsampling the sample density distribution by a factor of eight. Thus the sample map being generated has dimensions of the frame being generated (and sample map) downsampled by a factor of eight, such that each sampling position in the sample map is representative of a block of 8×8 sampling positions in the frame being generated.

In the present embodiment, the downsampling is performed by a max-pooling operation. This means that each sampling position in the sample map will have a value equal to the maximum value sampling position of the corresponding 8×8 sampling positions in the sample density distribution map.

Each sampling position of the downsampled sample map is representative of a corresponding 8×8 block in the frame to be generated, with each sampling position containing an integer number value which is roughly representative of the number of ray tracing samples to be traced for (the sampling positions of) the corresponding 8×8 block.

In step 703, the values of each sampling position in the sample map are summed together to provide a sample map total value. (As discussed further below, this sample map total value is used to later normalise the sample map values based on the total sample budget for the frame, in step 706).

In step 704 a group of 16 threads is allocated to (and dispatched for) a particular 8×8 block of sampling positions in the frame being generated, which (as discussed above) corresponds to a (single) particular sampling position in the downsampled sample map.

The group of 16 threads is allocated to the particular 8×8 block of sampling positions for the purpose of performing ray tracing for (the sampling positions of) the block. Each of the 16 threads are allocated a different 2×2 “quad” of four sampling positions of the 64 sampling positions that make up the 8×8 block. Each thread performs ray tracing in respect of the four sampling positions to which it has been allocated. Thus each of the 16 threads of the thread group is allocated to (and performs ray tracing for) a different four of the 64 sampling positions of the 8×8 block, such that ray tracing is performed for all 64 of the sampling positions of the 8×8 block.

Steps 705-707 are carried out in respect of the group of 16 threads (that has been allocated to the particular 8×8 block), and relate to the process of determining a number of rays to be traced by each thread (of the thread group) for the (2×2 “quad” of) four sampling positions that it has been allocated to. Steps 708-716 are carried out by a thread that has been allocated to a particular 2×2 “quad” of sampling positions, and relate to the process for tracing rays for those sampling positions. The same steps are performed by each of the 16 threads that are assigned to the particular 8×8 block, so that ray tracing is performed in respect of the entire 8×8 block.

In step 705 the sample map value in the downsampled sample map for the particular 8×8 block in question is read.

In step 706, the sample map value read for the 8×8 block in question is (i) normalised, and this normalised value is then (ii) rounded up or down to a multiple of 16. The resultant “rounded value” that is determined in this step can be thought of as representing the total number of rays to be traced for the 8×8 block in question by the 16 threads of the thread group allocated to the block.

The normalisation substep (i) of step 706 is performed by first multiplying the sample map value for the 8×8 block in question by the total “budget” B of ray tracing samples for the frame, i.e. the total number of rays to be traced when generating the (entirety of) the frame (as discussed above), divided by the sample map total (determined in step 703).

As will be understood, rounding the subsequent value in substep (ii) of step 706 to a multiple of 16 ensures that the total number of rays to be traced for the 8×8 block of sampling positions can be evenly distributed amongst the 16 threads of the work group. This means that each of the 16 threads in the thread group can trace a same number of rays, thereby ensuring that they complete their allocated work in a roughly equal time period (to ensure coherency).

In step 707, the “rounded value” for the 8×8 block calculated in step 706 is used to calculate a number of rays per thread (RPT) according to the formula:

RPT=(“rounded value”+16)/16

The RPT is the number of rays to be traced by the thread for the particular 2×2 quad of sampling positions (of the 8×8 block) which it has been allocated to. Thus, for example, a RPT value of three would mean that the thread is to trace three rays (in total) for the four sampling positions to which it has been allocated.

In some instances, the “rounded value” for the block may be equal to 0. Adding 16 to the “rounded value” therefore ensures that the RPT will be 1 at a minimum, i.e. meaning that the thread will trace at least one ray for the four sampling positions which it has been allocated to.

As previously discussed, each thread of the thread group of 16 threads allocated to a given 8×8 block of the frame being generated is allocated to a 2×2 quad of four sampling positions of the block. Steps 709-715 represent the process of cycling over each of those four sampling positions for the purposes of actually performing the ray tracing in respect of (at least some of) those four sampling positions.

The I iteration value is set to 0 (step 708) and then value J is calculated (step 709). The J value represents a particular sampling position in the group of four sampling positions that the thread. More particularly, J=0 represents the top left sampling position in the 2×2 quad of sampling positions, J=1 represents the top right sampling position in the 2×2 quad of sampling positions, J=2 represents the bottom left sampling position in the quad of sampling positions, J=3 represents the bottom right sampling position in the quad of sampling positions. Incrementing the value of J therefore causes the thread to cycle through the sampling positions of the quad in a “z” shape.

As can be seen, the current J value (and hence sampling position in question) is calculated based on the current I value, a random value generated in respect of the particular thread ID (“random (threadID)”), and a “shift” value. As will be discussed further below, the “random (threadID)” value represents a random value that is unique to the thread in question, whereas the “shift” value is incremented in successive frames (see 716).

In step 710, one or more rays are traced by the thread for the particular sampling position in question. The number of rays to be traced for the sampling position in question (i.e. the “ray count”), is determined by the formula:

Ray count=RPT/4+(I<RPT % 4)

(As will be understood, RPT/4 gives the quotient and RPT % 4 gives the remainder and (I<RPT % 4) is a Boolean expression which returns 1 when the condition is TRUE, and 0 otherwise. As discussed further below, this expression ensures that (in a case where the RPT is not perfectly divisible by 4) more rays are traced for sampling positions earlier in the cycle.)

If the ray count is >0 (step 711), i.e. if one or more rays were traced for the sampling position in question in step 710, then the value returned by performing the ray tracing for the sampling position (or an average of such values, if multiple rays were traced in respect of the sampling position) is added for the sampling position in the image and history buffers (step 712). If the ray count is 0, i.e. if no rays were traced for the particular sampling position in step 710 for the frame being generated, then a value for the sampling position from the history buffer is used for the image buffer (step 713).

If I<3 (step 714), which means that the thread has yet to cycle through all four sampling positions in the group of four sampling positions which it manages, then I is incremented by 1 (step 715) and a new J value is determined, which represents the next sampling position in the group of four sampling positions for which the thread is to perform ray tracing.

The thread will then cycle over all four sampling positions in the quad of sampling positions that it is allocated to, as I is incremented from 0 to 1 to 2 to 3.

If I has reached a value of 3, then reaching step 714 indicates that the thread has now cycled over each of the four sampling positions to which it has been allocated. At this point, the thread has finished tracing rays for the four sampling positions.

Before the thread is terminated, the “shift” value (which is used in the determination of J according to step 709) is updated (716), which is relevant for the next (i.e. subsequent) frame to be rendered. This means that the first J value for the next frame to be generated, calculated according to step 709, will be different to the first J value of the most recently generated frame

Steps 708-715 therefore relate to the process of tracing 0, 1 or more rays for each of the four sampling positions that the thread is allocated, as the thread cycles over the four sampling positions.

As will be understood, the first J value that is calculated, i.e. when I=0, represents the starting point for the thread when cycling over the four sampling positions. As I increments, the J value will also cycle such that the thread iterates over the other three sampling positions in the quad.

Depending on the RPT value for the thread in question, different numbers of rays may be traced for different sampling positions of the quad of sampling positions. More particularly, in the case wherein the RPT is not divisible by 4 (i.e. such that it is not possible to trace an equal (integer) number of rays for each of the four sampling positions in the quad), earlier sampling positions in the cycle will have more rays traced for them than later sampling positions in the cycle.

For example, in a case wherein the RPT=3, this means that three rays are to be traced by the thread for the four sampling positions to which it is allocated. If, at the start of the iteration (i.e. when I=0) the J value is equal to 2. This means that, when performing ray tracing for the quad of sampling positions, the thread will begin at the bottom left sampling position in the quad. The ray count determined in step 710 is equal to 1 (since, referring to the formula for determining in ray count in step 710 above: RPT/4=0 and RPT % 4=3 when RPT=3, and hence (I<RPT % 4) is TRUE (i.e. =1) when I=0), and so a single ray will be traced for this sampling position.

When I is increased by 1 to 1 (in step 715), the new J value determined in step 709 will correspondingly increase to 3, indicating that the thread will move on to the sampling position in the bottom right of the quad. The ray count determined in step 710 will once again be equal to 1, and so a single ray will also be traced for this sampling position.

When I is increased to 2 (in step 716), the new J value determined in step 709 will be 0, indicating that the thread will move onto the sampling position at the top left of the quad. The ray count determined in step 710 will once again be equal 1, and so a single ray will also be traced for this sampling position.

When I is increased to 3 (in step 716), the new (and final) J value determined in step 709 will be 1, indicating that the thread will move on to the final sampling position at the top right of the quad. However, at this point, the ray count value determined in step 710 will be equal to 0 (since in this case I<RPT % 4 is FALSE (i.e. equal to 0) when I=3), indicating that there are no more rays available to be traced.

At this point, all of the sampling positions have been cycled over. Thus in this example, the first three sampling positions cycled over would have a ray traced for them, but the final sampling position (in the top right of the quad) would not have a ray traced.

Referring once again to step 709, the initial J value that is determined when I=0 (i.e. the starting point of the iteration over the four sampling positions, as discussed above) is dependent on the values of “random (threadID)” and “shift”.

The “random (threadID)” value is equal to a random number that is unique to the thread in question. Thus, different threads will have a different “random (threadID)” value. This means, accordingly, that different threads (which, as discussed above, have been assigned to different quads of sampling positions) will have a different J value when I=0 (and when the “shift” value is the same). Thus each thread will have a different starting position in their iteration over the four sampling positions to which they have been assigned, relative to other threads.

As discussed above, the starting point of the cycling affects the way ray tracing samples are distributed amongst the four sampling positions, since sampling positions at an earlier point of the cycle may receive more ray tracing samples than sampling positions at a later point of the iteration. By having each thread of a thread group allocated to an 8×8 block starting their iteration at a random sampling position in their quad of sampling positions relative to other threads in the thread group, this prevents any structured pattern (resulting from the sampling positions receiving new ray tracing samples) being introduced in the image (frame) being generated.

As discussed above, the “shift” value is incremented between frames that are generated. This means, accordingly, that the initial J value when I=0 (i.e. the starting point for the thread's cycling over the sampling positions in its quad) will also cycle in successive frames. Since the thread will always be allocated at least one ray to trace for the four sampling positions it manages (see step 707 above), this ensures that each of the four sampling positions will get a new ray tracing sample one every four frames (according to step 712), thereby preventing any one sampling position in the quad from ever being starved of a new ray traced value for more than three frames.

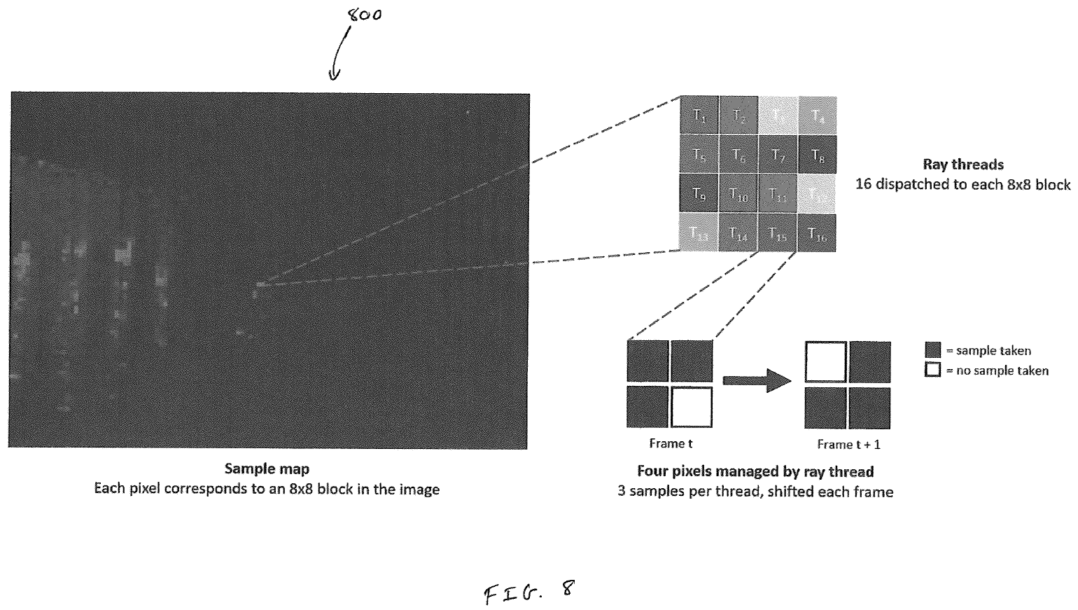

FIG. 8 shows the effect of cycling the starting point of the thread iteration (by incrementing the “shift” value) according to this embodiment of the technology described herein in further detail.

FIG. 8 shows an example downsampled sample map 800, that is calculated for a frame being generated according to step 702. As discussed above, each sampling position in the sample map represents a 8×8 block of sampling positions in the frame to be generated, with each sampling position value indicating a relative number of ray tracing samples to be allocated when rendering that 8×8 block.

FIG. 8 shows a sampling position in the downsampled sample map 800 that is representative of a block of 8×8 sampling positions, to which a group of 16 threads T1-T16 is allocated to the block. In this embodiment, as discussed above, each thread of the work group is allocated to a respective 2×2 quad of four sampling positions.

The four sampling positions managed by thread T15 are shown in further detail. In this example, the RPT (rays per thread) is equal to 3 for two consecutive frames that are generated (a first frame at time t, and a second frame at time t+1). This means that, for each frame being generated, a total of three ray samples are traced when T15 is executed, with 1 ray traced for each of the first three sampling positions (of the quad) that the thread iterates over (in the manner discussed above in relation to FIG. 7), and no ray traced for the other (final) sampling position that is iterated over. This is illustrated in FIG. 8 by the three filled black squares (indicating sampling positions where a ray is traced) and the one unfilled square (indicating a sampling position where no ray is traced).

However, as can be seen, the cycling of the starting point between frames in (the manner described above) resulting from the incrementation of the “shift” value in step 716 means that the sampling position for which no ray is traced (shown as the unfilled square) is different for the two successive frames being generated.

When generating the first frame at t, when thread T15 begins its cycle over the four sampling positions in the quad (i.e. when I=0), the J value (calculated in step 709 of FIG. 7) is 0. This means that thread T15 begins its cycle over the four sampling positions of the quad at the sampling position in the top left position of the quad. A ray is traced for the first three sampling positions that the thread cycles through (i.e. the sampling positions in the top left, top right and bottom left positions in the quad), but no ray is traced for the final sampling in the cycle (i.e. the sampling position in the bottom right position in the quad). The “shift” value is then incremented by 1 according to step 716.

When the second frame at time t+1, when thread T15 beings its cycle its cycle over the four sampling positions in the quad (i.e. when I=0), the J value (calculated in step 709 of FIG. 7) is now 1, since the “shift” value has been incremented by 1 compared to the previous frame. This means that thread T15 begins its cycle over the four sampling positions of the quad at the sampling position in the top right position of the quad. A ray is traced for the first three sampling positions that the thread cycles through (i.e. the sampling positions in the top right, bottom left and bottom right positions in the quad), but no ray is traced for the final sampling in the cycle (i.e. the sampling position in the top left position in the quad). The “shift” value is then incremented by 1 according to step 716.

The process of updating the “shift” value between each frame therefore ensures that each of the sampling positions will have a ray traced for them at least once every four frames.

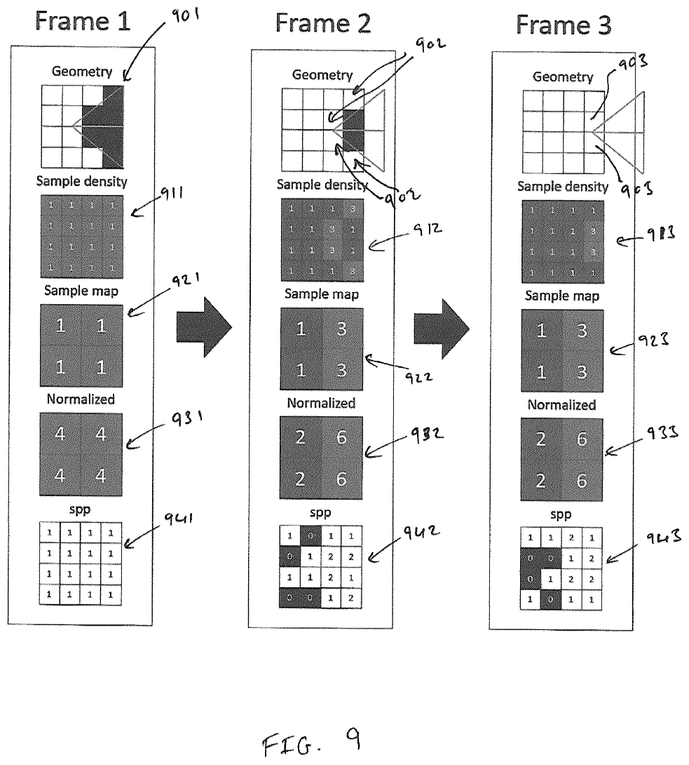

FIG. 9 illustrates a process for allocating rays to be traced when generating three consecutive frames for display, in accordance with an embodiment of the technology described herein.

In the embodiment shown in FIG. 9, each of the frames being generated are 4×4 sampling positions in size, and there is a total ray tracing budget of 16 rays for each of the frames. In other words, there are 16 ray tracing samples to be spread across each of the frames to be rendered, in accordance with the technology described herein.

(In various other embodiments, the frame to be generated will comprise many more sampling positions than this, and the ray tracing budget will also be greater. However, FIG. 9 is intended to show how changes in a scene that is rendered can affect the way ray tracing samples are allocated according to the method of the technology described herein, and so a small size of frame with a small ray tracing budget has been chosen for simplicity.)

In this embodiment, a single thread (i.e. a “group” of one thread) is allocated to each 2×2 block (i.e. quad) of sampling positions of the frame. Thus, to perform the ray tracing for the 4×4 frame to be generated, four different threads are allocated to the four respective 2×2 blocks (quads) that make up the frame, with the number of rays that each thread traces for the sampling positions of their respective block being determined in accordance with the technology described herein (and as described further below). (Again, in various other embodiments, the number of threads in each thread “group” allocated to a block of the frame being generated will be much larger than one.)

An earlier stage of the rendering pipeline provides prior data to which indicates which of the sampling positions in the frame to be rendered are disoccluded. A sample density map is then generated from this prior data.

As can be seen from FIG. 9, the sample density map that is generated for each frame is a 4×4 array of sampling positions (i.e. the same size as the frame to be generated), with each sampling position in the sample density corresponding to a sampling position of the frame being generated. In this embodiment, when generating the sample density, the compute shader assigns each sampling position of the sample density corresponding to a disoccluded sampling position a value of 3, but assigns all other (non-disoccluded sampling positions) a value of 1.

A downsampled sample map is then generated based on the generated sample density. In this embodiment, the sample map is generated by downsampling the sample density (via max pooling) by a factor of 2. Thus the downsampled sample map comprises four sampling positions, Each sampling position representing a 2×2 block of sampling positions of the frame to be generated.

A “normalised” downsampled sample map is then generated, based on the downsampled sample map and the ray tracing budget for the frame (i.e. 16 rays). This is done by multiplying each value in the (non-normalised) downsampled sample map by the ray tracing budget 16, divided by the total of all the values in (non-normalised) downsampled sample map. Each value in the normalised downsampled sample map indicates the actual number of rays that should be traced for the corresponding 2×2 block.

A thread (i.e. a thread “group” of one thread) is then allocated to each 2×2 block to perform ray tracing for the block. Each thread performs ray tracing for the 2×2 block that it is allocated, and traces a number of rays for the block in accordance with the corresponding value for the block from the normalised downsampled sampled map. This is done by the thread iterating (cycling) over each of the four sampling positions in the 2×2 block (in the manner discussed above). In cases wherein the number of rays to be traced by a thread is not a multiple of four, earlier sampling positions in the cycle will have more rays traced for them than later sampling positions in the cycle (in the manner discussed above). The number of rays that are traced for each sampling position of the block is shown in the spp (sample per pixel) map

In the first frame to be generated (“Frame 1), a right hand portion of the frame is occluded by a triangle 901. In the second frame (“Frame 2”), the triangle has moved slightly further to the right, which causes four sampling positions 902 (which were occluded in Frame 1) to de “disoccluded”. In the final frame (“Frame 3”), the triangle has moved out of the frame altogether, thereby causing two further sampling positions 903 to be disoccluded.

Frame 1 has no disoccluded sampling positions. Therefore when generating the sample density map 911 for Frame 1, all of the sampling positions are simply assigned a value of 1. Since the sample density for Frame 1 consists of all 1 values, the downsampled sample map 921 for Frame 1 also consist of all 1 values. Since each of the four 2×2 blocks have equal weighting in this case (i.e. the rays to be traced are to be equally spread over the frame), the normalised sample map 931 consists of all “4” values (thereby indicating 4 rays to be traced for each of the four 2×2 blocks, i.e. 16 rays in total).

Each thread therefore traces 4 rays for the 2×2 block they are allocated to, which corresponds to 1 ray per sampling position of the block. This is indicated by spp (“sample per sampling position”) map 941 consisting of all “1” values.

As discussed above, Frame 2 has four disoccluded sampling positions. Therefore when generating the sample density 912 for Frame 2, a value of “3” is assigned for those four disoccluded sampling positions, and a value of “1” is assigned for each of the other sampling positions.

This results in the downsampled sample map 922 for Frame 2. As shown, the sampling positions corresponding to the two 2×2 blocks on the right side of the frame being generated (i.e. the blocks containing the disoccluded sampling positions) have a value “3”, whereas the sampling positions corresponding to the two 2×2 blocks on the left side of the frame have a value of “1”.

Normalising the downsampled sample map 922 results in the normalised downsampled sample map 932 for frame 2. As shown, the sampling positions corresponding to the two 2×2 blocks on the right side of the frame being generated (i.e. the blocks containing the disoccluded sampling positions) have a value “6”, whereas the sampling positions corresponding to the two 2×2 blocks on the left side of the frame have a value of “2”. This means that 6 rays are to be traced for the four sampling positions of the upper right 2×2 block, and 6 rays are to be traced for the four sampling positions of the lower right 2×2 block, but only 2 rays are to be traced for the four sampling positions of the upper left 2×2 block and only 2 rays are to be traced for the four sampling positions of the lower left 2×2 block.

As shown by the spp map 942, the thread allocated to the upper right block traces two rays for each of the the first two sampling positions it cycles through, and one ray for each of the latter two sampling positions it cycles through (thereby tracing 6 rays in total). Similarly the thread allocated to the lower right block will also two rays for each of the first two sampling positions it cycles through, and one ray for each of the latter two sampling positions it cycles over (thereby tracing 6 rays in total).

By contrast, the thread allocated to the upper left block will trace one ray for each of the first two sampling positions it through, and zero rays for each of the latter two sampling positions it cycles through (thereby tracing 2 rays in total). Similarly, the thread allocated to the lower left block will trace one ray for each of the first two sampling positions it through, and zero rays for each of the latter two sampling positions it cycles through (thereby tracing 2 rays in total).

As discussed above, Frame 3 has two disoccluded sampling positions. Therefore when generating the sample density 913 for Frame 3, a value of “3” is assigned for those four disoccluded sampling positions, and a value of “1” is assigned for each of the other sampling positions.

This results in the downsampled sample map 922 for Frame 2. As shown, the sampling positions corresponding to the two 2×2 blocks on the right side of the frame (i.e. the blocks containing the disoccluded sampling positions) have a value “3”, whereas the sampling positions corresponding to the two 2×2 blocks on the left side of the frame have a value of “1”

This translates into normalised downsampled sample map 933 for frame 3. As shown the two 2×2 blocks on the right side (i.e. the blocks containing the disoccluded sampling positions) have a value “6”, whereas the two 2×2 blocks on the left side have a value of “3”. This means that 6 rays are to be traced for the four sampling positions of the upper right 2×2 block, and 6 rays are to be traced for the four sampling positions of the lower right 2×2 block, but only 2 rays are to be traced for the four sampling positions of the upper left 2×2 block and only 2 rays are to be traced for the four sampling positions of the lower left 2×2 block.

As shown by the spp map 943, the thread allocated to the upper right block traces two rays for each of the first two sampling positions it cycles through, and one ray for each of the latter two sampling positions it cycles through (thereby tracing 6 rays in total). Similarly the thread allocated to the lower right block will also trace two rays for each of the first two sampling positions it cycles through, and one ray for each of the latter two sampling positions it cycles over (thereby tracing 6 rays in total).

By contrast, the thread allocated to the upper left block will trace one ray for each of the first two sampling positions it through, and zero rays for each of the latter two sampling positions it cycles through (thereby tracing 2 rays in total). Similarly, the thread allocated to the lower left block will trace one ray for each of the first two sampling positions it through, and zero rays for each of the latter two sampling positions it cycles through (thereby tracing 2 rays in total).

(It should be noted here that, even though the thread allocated to each block in Frame 2 traces the same number of rays to the thread allocated to the corresponding block in Frame 3, the distribution of rays to be traced for the sampling positions in those blocks is different, which can be seen by comparing spp maps 942 and P43. This is due to the “shift” value, which is incremented between frames, causing the starting point of each thread's iteration over its sampling position to change (in the manner discussed above)).

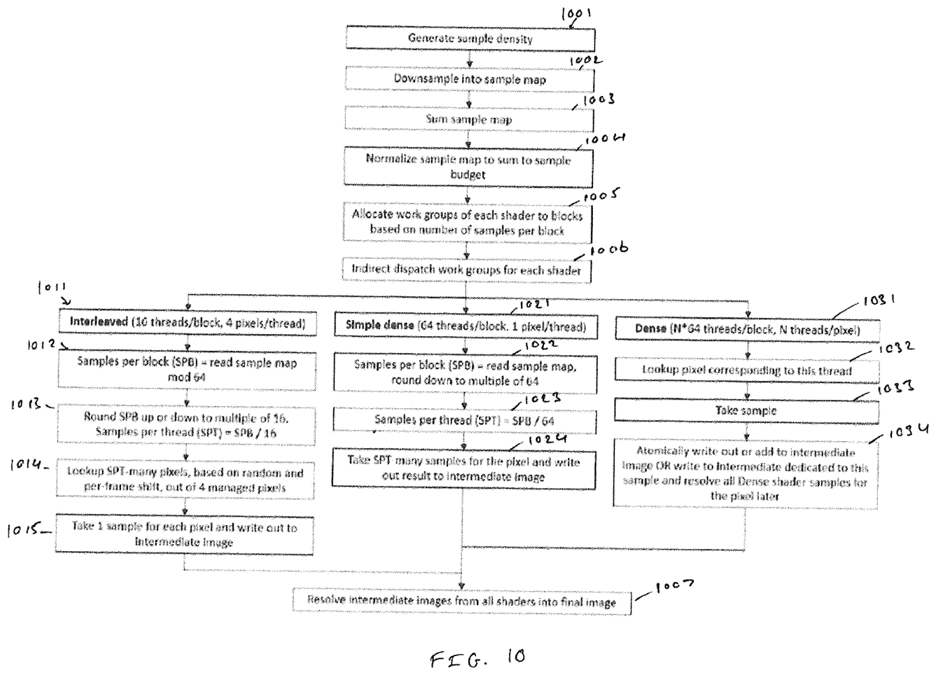

FIG. 10 shows a flow diagram of a ray tracing process according to an embodiment of the technology described herein.

In the embodiment shown in FIG. 7, discussed above, a (single) group of sixteen threads is allocated to each 8×8 block of the frame being generated, such that each thread is allocated to (and traces ray samples for) a quad of four sampling positions.

Groups of sixteen threads are also allocated to 8×8 blocks of the frame being generated in the embodiment shown in FIG. 10. The embodiment shown in FIG. 10 differs from the embodiment of FIG. 7, however, in that the numbers of groups of 16 threads to be allocated to respective 8×8 blocks is chosen based on the number of rays to be traced for the block (i.e. the number of ray tracing samples for the block). A (single) group of 16 threads is allocated blocks with a relatively low number of rays to be traced (such that each thread is allocated to a quad of four sampling positions), but four groups of 16 threads (i.e. 64 threads in total) are allocated to blocks with a higher number of rays to be traced (i.e. such that each thread is allocated to single sampling position), and N times four work groups, i.e. N*64 threads in total are allocated to blocks with very high numbers of rays to be traced (such that N threads are allocated to each sampling position).

The embodiment shown in FIG. 10 also differs from the embodiment of FIG. 7 in that the step of normalising the value(s) of the downsampled sample map is carried out before work groups are allocated to blocks (rather than after).

At the beginning of the process, some prior data is received as an input which provides an indication as to which portions of the frame being generated would benefit from more ray tracing samples relative to other portions of the frame because they relate to disocclusions.

In step 1001, a sample density distribution map is generated based on the prior data indicating the areas of the frame that are disocclusions (similarly to step 701).

In step 1002, a downsampled sample map is generated from the sample density distribution map. This is done by downsampling the sample density distribution map by a factor of eight via max pooling (similarly to step 702). Thus the sample map being generated has dimensions of the frame being generated downsampled by a factor of eight, such that each sampling position in the sample map is representative of a block of 8×8 sampling positions in the frame being generated.

In step 1003, the values of each sampling position in the downsampled sample map are summed together to provide a sample map total.

In step 1004, the values for each sampling position in the downsampled sample map (which corresponds to each 8×8 block of the frame being generated) are normalised to generate a normalised sample map. This is done by multiplying each value in the downsampled sample map by total “budget” B of ray samples for the frame, i.e. the total number of rays to be traced when generating the (entirety of) the frame (as discussed above), divided by the sample map total (determined in step 1003).

The normalised value for each sampling position in the normalised sample map (roughly) represents a total number of rays to be traced (i.e. total ray tracing samples) for the corresponding 8×8 block of sampling positions in the frame being generated (subject to some rounding, as will be discussed further below).

In step 1005, group(s) of 16 threads are allocated to each of the 8×8 blocks of sampling positions in the frame being generated, for the purpose of performing ray tracing for the blocks. In step 1006, the group(s) of 16 threads are dispatched to the 8×8 blocks they are allocated to.

However, the number of groups of 16 threads that are allocated (and dispatched) to each 8×8 block is determined based on the (estimated) number of rays to be traced for the block, i.e. the corresponding value in the normalised sample map (from which a number of ray tracing sample per sampling position can be determined).

A (single) group of 16 threads is allocated to each block having a number of ray tracing samples per sampling position (spp) of under 1.0, corresponding to a value in the normalised sample map of under 64, indicating the block has relatively few rays to be traced for it. These blocks follow the “interleaved” steps 1011-1015. In this case, each thread of the thread group is allocated to (and performs ray tracing for) a respective 2×2 quad of four sampling positions (in a similar manner to the process shown in FIG. 7, described above).

Four groups of 16 threads are allocated to each block having a number of ray tracing samples per sampling position (spp) of over 1.0, corresponding to a value in the normalised sample map of over 64, indicating that the block has relatively many rays to be traced for it. These blocks follow the “simple dense” steps 1021-1024. In this case, each thread of each thread group is allocated to (and performs ray tracing for) a respective single sampling position (i.e. such that there is a 1:1 mapping between threads and sampling positions of the block).

4N groups of 16 threads are allocated to each block having very many rays to be traced (i.e. where the number of ray tracing samples per sampling position is much greater than 1.0). These blocks follow the “Dense” steps 1031-10 34. In this case, each thread of each thread group will be allocated to a single sampling position, but each sampling position will have N threads allocated to it (such that there is an N:1 mapping between threads and sampling positions of the block). Each thread traces one ray for the sampling position it is allocated to.

For blocks following the “interleaved” process (step 1011) the total number of rays to be traced (i.e. the number of ray tracing samples) per block (SPB) is determined by reading the value of the sample map for the block, mod 64 (step 1012).

The resultant value SPB is then rounded up or down to a multiple of 16 and divided by 4 in order to determine the number of rays to be traced for each thread (i.e. the samples per thread (SPT)) (step 1013). This is the number of rays each thread will trace (i.e. the number of samples) for the four sampling positions that the thread is allocated to. Thus, for example, an SPT of 2 means that 2 samples will be distributed amongst the 4 sampling positions of each thread.

As will be understood, rounding to the nearest multiple of 16 ensures that total number of rays to be traced for the block can be evenly distributed amongst the 16 threads of the work group (allocated to the block). This means that each of the 16 threads in the thread group can trace a same number of rays, thereby ensuring that they complete their allocated work in a roughly equal time period (to ensure coherency).

In step 1014, a lookup is performed to SPT-many sampling positions of the four sampling positions of the quad that the thread is allocated to, and the SPT-many sampling positions (retrieved in the lookup of step 1014) have rays traced for them (with one ray being traced (i.e. one ray tracing sample) for each of those sampling positions) (step 1015). This process may be carried out by the thread cycling over each sampling position in the quad, e.g. according to the process of steps 708-715 in the embodiment of FIG. 7. The value returned by the rays that are traced is written out into an intermediate image

For blocks following the “simple dense” process (step 1021) the total number of rays to be traced (i.e. the number of ray tracing samples) per block (SPB) is determined by reading the value of the sample map for the block, rounded down to a multiple of 64 (step 1022).

As will be understood, rounding down to a multiple of 64 ensures that the total number of rays to be traced for the block can be evenly distributed amongst the 64 threads allocated to the block (i.e. the 16 threads of each of the four thread groups). This means that each of the 64 threads across the four thread groups can trace a same number of rays for the sampling position they are allocated to, thereby ensuring that they complete their allocated work in a roughly equal time period (to ensure coherency).

In step 1023, the samples per thread SPT, i.e. the number of rays to be traced by each thread for the sampling position it is allocated to, is calculated by dividing the SPB by 64.

In step 1024, SPT-many rays are traced (i.e. samples taken) by each thread for the sampling position it is allocated to, and the result is written out to an intermediate image.

For blocks following the “dense” process (step 1031), each thread will trace a single ray for the sampling position it is allocated to. Each thread looks up the sampling position to which it is allocated (step 1032) and traces a ray (i.e. takes a sample) for that sampling position (1033).

Since, in this “dense” case, multiple threads are allocated to (and perform ray tracing for) each sampling position, each thread may write out (or add) its ray tracing result to the intermediate image. Alternatively, the result may be written out to a buffer separate to the intermediate (in a memory location specific to the thread in question), with the value from that separate buffer then written to the intermediate image once all of the rays have been traced for the sampling position.

In the final step, the intermediate images from all thread groups/blocks are resolved into the final frame image (step 1007).

The ray tracing processes shown in FIG. 7 and FIG. 10 (and described above) are carried out by one or more compute shaders (although it would of course be possible to carry out the processes using any combination of software and hardware, as desired).

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

What is claimed is:

1. A method of operating a graphics processor to generate a render output made up of a plurality of sampling positions by performing a ray tracing process in which rays are traced through a scene to be rendered, wherein the total number of rays to be traced when generating the render output is based on a ray tracing budget B, and wherein different numbers of rays can be traced for different regions of the render output, the method comprising:
determining relative numbers of rays to be traced for different regions of the render output;
allocating M groups of threads to a region of the render output to perform the ray tracing for the region of the render output, each thread of the M groups of threads being allocated to a subregion of the region to perform ray tracing for the subregion;
determining the number of rays to be traced by each thread of the M groups of threads when performing ray tracing for the subregion to which they have been allocated, based on the relative number of rays to be traced for the region of the render output and the budget B of rays to be traced when generating the render output; and
performing ray tracing for the region, including each of the threads tracing the determined number of rays for the subregion to which they have been allocated.

2. The method of claim 1, wherein the relative number of rays to be traced for different regions of the render output is determined based on data indicating the presence of sampling positions in one or more different regions of the render output that could particularly benefit from receiving more ray tracing samples.

3. The method of claim 2, wherein the data indicating the presence of sampling positions in one or more different regions of the render output that could particularly benefit from receiving more ray tracing samples comprises one or more of:
data indicating an area of disocclusion for the region;
data indicating an area of specular highlights for the region;
data indicating an area of high spatiotemporal variance and/or soft shadows; and
data from a learned algorithm or neural network, optionally feedback data from a denoiser.

4. The method of claim 1, wherein the number M of groups of threads allocated to a region of the render output is determined based on a determined number of rays that are to be traced for the region.

5. The method of claim 1, wherein determining the number of rays to be traced by each thread of the M groups of threads when performing ray tracing for the subregion to which they have been allocated comprises:
determining an approximate number of rays to be traced for the region of the render output by multiplying the relative number of rays to be traced for the region by the ray tracing budget B, divided by the sum of all the relative numbers of rays to be traced for all of the regions of the render output.

6. The method of claim 5, wherein each of the M groups of threads comprises N threads, and the method further comprises rounding the determined approximate number of rays to be traced for the region to a nearest multiple of M*N, and dividing this rounded value by M*N to give the number of rays to be traced by each of the M*N threads when performing ray tracing for the subregion to which they have been allocated.

7. A method of operating a graphics processor to generate a render output made up of a plurality of sampling positions by performing a ray tracing process in which rays are traced through a scene to be rendered, the method comprising:
allocating a plurality of threads to a region of the render output, each thread being allocated to a subregion of the region to perform ray tracing for the subregion, each of the subregions of the region comprising a plurality of sampling positions; and
performing ray tracing for the region, including each of the threads tracing rays for its allocated subregion by cycling over sampling positions of its allocated subregion in turn to trace one or more rays for one or more of the sampling positions of the subregion.

8. The method of claim 7, wherein the number of rays to be traced by each of the threads for the subregion to which they have been allocated is not a multiple of the number of sampling positions that each subregion comprises; and the method comprises:
each thread tracing a different number of rays for one or more sampling positions of the subregion compared to other sampling positions of the subregion, based on the order that the thread cycles over the sampling positions.

9. The method of claim 8, comprising each thread starting the cycling over the sampling positions of its allocated subregion at a random sampling position of the subregion relative to the sampling position at which each other thread starts its cycle over the sampling positions of its allocated subregion.

10. The method of claim 8, comprising repeating the method to successively generate one or more further render outputs having corresponding regions, each corresponding region comprising a corresponding set of subregions, each corresponding subregion being allocated to a same thread, and the method further comprises:
each thread cycling the sampling position at which the thread starts cycling over the sampling positions of each corresponding subregion to which it is allocated, when generating successive render outputs.

11. A graphics processor that is operable to generate a render output made up of a plurality of sampling positions by performing a ray tracing process in which rays are traced through a scene to be rendered, wherein the total number of rays to be traced when generating the render output is based on a ray tracing budget B, and wherein different numbers of rays can be traced for different regions of the render output, the graphics processor comprising:
a processing circuit configured to determine relative numbers of rays to be traced for different regions of the render output;
a thread group allocation circuit configured to allocate M groups of threads to a region of a render output to perform ray tracing for the region of the render output, each thread of the M groups of threads being allocated to a subregion of the region to perform ray tracing for the subregion;
a number of rays determining circuit configured to determine the number of rays to be traced by each thread of the M groups of threads when performing ray tracing for the subregion to which they have been allocated, based on the relative number of rays to be traced for the region of the render output and the budget B of rays to be traced when generating the render output; and
one or more processing circuits configured to perform ray tracing for a region of a render output, including each of the threads tracing the determined number of rays for the subregion to which they have been allocated.

12. The graphics processor of claim 11, wherein the processing unit is configured to determine the relative number of rays to be traced for different regions of a render output based on data indicating the presence of sampling positions in one or more different regions of a render output that could particularly benefit from receiving more ray tracing samples.

13. The graphics processor of claim 12, wherein the data indicating the presence of sampling positions in one or more different regions of the render output that could particularly benefit from receiving more ray tracing samples comprises one or more of:
data indicating an area of disocclusion for the region
data indicating an area of specular highlights for the region;
data indicating an area of high spatiotemporal variance and/or soft shadows; and
data from a learned algorithm or neural network, optionally feedback data from a denoiser.

14. The graphics processor of claim 11, wherein the thread group allocation circuit is configured to determine the number M of groups of threads allocated to a region of the render output based on a determined number of rays that are to be traced for the region.

15. The graphics processor of claim 11, wherein the number of rays determining circuit is configured to determine the number of rays to be traced by each thread of the M groups of threads when performing ray tracing for the subregion to which they have been allocated by:
determining an approximate number of rays to be traced for the region of the render output by multiplying the relative number of rays to be traced for the region by the ray tracing budget B, divided by the sum of all the relative numbers of rays to be traced for all of the regions of the render output.

16. The graphics processor of claim 11, wherein each of the subregions of the region comprises a plurality of sampling positions, and each thread traces the determined number of rays for the subregion by cycling over sampling positions of its allocated subregion in turn to trace one or more rays for one or more of the sampling positions of the subregion.

17. The graphics processor of claim 16, wherein the number of rays to be traced by each of the threads for the subregion to which they have been allocated is not a multiple of the number of sampling positions that each subregion comprises; and
each thread traces a different number of rays for one or more sampling positions of the subregion compared to other sampling positions of the subregion, based on the order that the thread cycles over the sampling positions.

18. The graphics processor of claim 17, wherein each thread starts the cycling over the sampling positions of its allocated subregion at a random sampling position of the subregion relative to the sampling position at which each other thread starts its cycle over the sampling positions of its allocated subregion.

19. The graphics processor of claim 11, wherein the graphics processor is configured to, when successively generating one or more plural render outputs having corresponding regions, each corresponding region comprising a corresponding set of subregions, each corresponding subregion being allocated to a same thread:
cycle the sampling position at which each thread starts cycling over the sampling positions of each corresponding subregion to which it is allocated, when generating successive render outputs.

20. A non-transitory computer readable storage medium storing computer software code which, when executing on at least one processor, performs a method of operating a graphics processor to generate a render output made up of a plurality of sampling positions by performing a ray tracing process in which rays are traced through a scene to be rendered, wherein the total number of rays to be traced when generating the render output corresponds to a selected ray tracing budget B, and wherein different numbers of rays can be traced for different regions of the render output, the method comprising:
determining relative numbers of rays to be traced for different regions of the render output;
allocating M groups of threads, each group of threads comprising N threads, to a region of the render output to perform the ray tracing for the region of the render output, each thread being allocated to a subregion of the region to perform ray tracing for the subregion;
determining the number of rays to be traced by each of the M*N threads when performing ray tracing for the subregion to which they have been allocated, based on the relative number of rays to be traced for the region of the render output and the total budget B of rays to be traced when generating the render output; and
performing ray tracing for the region, including each of the threads tracing the determined number of rays for the subregion to which they have been allocated.
